(19) United States
(12) Patent Application Publication
(10) Pub. No.: US 2016/0345234 A1
(43) Pub. Date: Nov. 24, 2016

(54) FAST RETURN FAILURE HANDLING IN A WIRELESS NETWORK

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/715,506

(22) Filed: May 18, 2015

(51) Int. Cl. H04W 36/32; H04W 24/10; H04W 36/30

(52) U.S. Cl. CPC H04W 36/32; H04W 36/30; H04W 24/10

(57) ABSTRACT

A user equipment (UE) may reduce potential delay when attempting to return to a first radio access technology (RAT) after a circuit-switched fall back (CSFB) call releases at a second RAT. The UE may first determine its speed when the CSFB call releases. The UE then suspends a return to the first RAT without searching non-dedicated frequencies of the first RAT. This occurs when the UE speed is above a first predefined threshold and a signal quality of a dedicated frequency of the first RAT, included in a release message from a network of the second RAT or in a record of the UE, is below a second predetermined threshold. The UE may also search non-dedicated frequencies of the first RAT when the UE speed is below the first predefined threshold and the signal quality of the dedicated frequency of the first RAT is below the second predetermined threshold.

### BACKGROUND

1. Field

Aspects of the present disclosure relate generally to wireless communication systems, and more particularly, to fast return failure handling in a high-speed scenario in a wireless network.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

According to one aspect of the present disclosure, a method of wireless communication at a user equipment (UE) includes determining a speed of the UE when a circuit switched fallback (CSFB) call in a second radio access technology (RAT) releases. The method also includes suspending a return to a first RAT without searching non-dedicated frequencies of the first RAT when the speed of the UE is above a first predefined threshold and a signal quality of a dedicated frequency of the first RAT is below a second predetermined threshold. The dedicated frequency of the first RAT is either included in a release message from the second RAT or included in a record of the UE. The method also includes searching the non-dedicated frequencies of the first RAT when the speed of the UE is below the first predefined threshold and the signal quality of the dedicated frequency of the first RAT is below the second predetermined threshold.

According to another aspect of the present disclosure, an apparatus for wireless communication includes means for determining a speed of the UE when a circuit switched fallback (CSFB) call in a second radio access technology (RAT) releases. The apparatus also includes means for suspending a return to a first RAT without searching non-dedicated frequencies of the first RAT when the speed of the UE is above a first predefined threshold and a signal quality of a dedicated frequency of the first RAT is below a second predetermined threshold. The dedicated frequency of the first RAT is either included in a release message from the second RAT or included in a record of the UE. The apparatus also includes means for searching the non-dedicated frequencies of the first RAT when the speed of the UE is below the first predefined threshold and the signal quality of the dedicated frequency of the first RAT is below the second predetermined threshold.

According to another aspect of the present disclosure, an apparatus for wireless communication includes a memory and at least one processor coupled to the memory. The processor(s) is configured to determine a speed of the UE when a circuit switched fallback (CSFB) call in a second radio access technology (RAT) releases. The processor(s) is also configured to suspend a return to a first RAT without searching non-dedicated frequencies of the first RAT when the speed of the UE is above a first predefined threshold and a signal quality of a dedicated frequency of the first RAT is below a second predetermined threshold. The dedicated frequency of the first RAT is either included in a release message from the second RAT or included in a record of the UE. The processor(s) is also configured to search the non-dedicated frequencies of the first RAT when the speed of the UE is below the first predefined threshold and the signal quality of the dedicated frequency of the first RAT is below the second predetermined threshold.

In a further aspect, a computer program product for wireless communication includes a non-transitory computer-readable medium having encoded thereon program code. The program code includes program code to determine a speed of the UE when a circuit switched fallback (CSFB) call in a second radio access technology (RAT) releases. The program code further includes program code to suspend a return to a first RAT without searching non-dedicated frequencies of the first RAT when the speed of the UE is above a first predefined threshold and a signal quality of a dedicated frequency of the first RAT is below a second predetermined threshold. The dedicated frequency of the first RAT is either included in a release message from the second RAT or included in a record of the UE. The program code further includes program code to search the non-dedicated frequencies of the first RAT when the speed of the UE is below the first predefined threshold and the signal quality of the dedicated frequency of the first RAT is below the second predetermined threshold.

According to another aspect of the present disclosure, a method of wireless communication at a node of a dedicated network of a first radio access technology (RAT) is disclosed. The method includes sending a connection release message to a user equipment (UE) for a circuit switched fallback (CSFB) service including at least one dedicated frequency of the first RAT. The method may also include sending to the UE a second release message including at least one non-dedicated frequency of the first RAT.

In yet another aspect, an apparatus for wireless communication has a memory and at least one processor coupled to the memory. The processor(s) is configured to send a connection release message to a user equipment (UE) for a circuit switched fallback (CSFB) service including at least one dedicated frequency of the first RAT.

According to another aspect of the present disclosure, an apparatus for wireless communication includes means for sending a connection release message to a user equipment (UE) for a circuit switched fallback (CSFB) service including at least one dedicated frequency of the first RAT. The apparatus also has means for determining the dedicated frequency.

In still another aspect, a computer program product for wireless communication includes a non-transitory computer-readable medium having encoded thereon program code. The program code includes program code to send a connection release message to a user equipment (UE) for a circuit switched fallback (CSFB) service including at least one dedicated frequency of the first RAT.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas including a dedicated network and a public network according to aspects of the present disclosure.

FIG. 5 is a flow diagram conceptually illustrating an example process for fast return failure handling in a high-speed scenario according to one aspect of the present disclosure.

FIG. 6 is a flow diagram illustrating an example decision process for fast return failure handling in a high-speed scenario according to one aspect of the present disclosure.

FIG. 7 is a flow diagram illustrating a method for fast return failure handling at a UE in a high-speed scenario according to one aspect of the present disclosure.

FIG. 8 is a flow diagram illustrating a method for fast return failure handling at a network node in a high-speed scenario according to one aspect of the present disclosure.

FIGS. 9 and 10 are block diagrams illustrating different modules/means/components for fast return failure handling in a high-speed scenario in an example apparatus according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

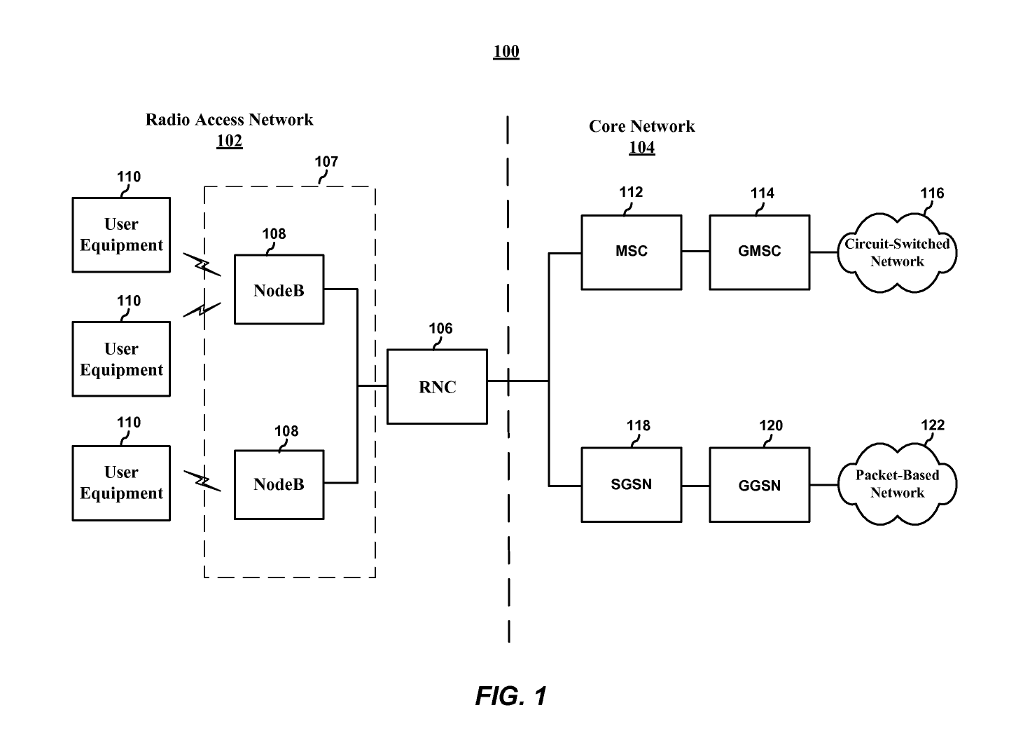

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

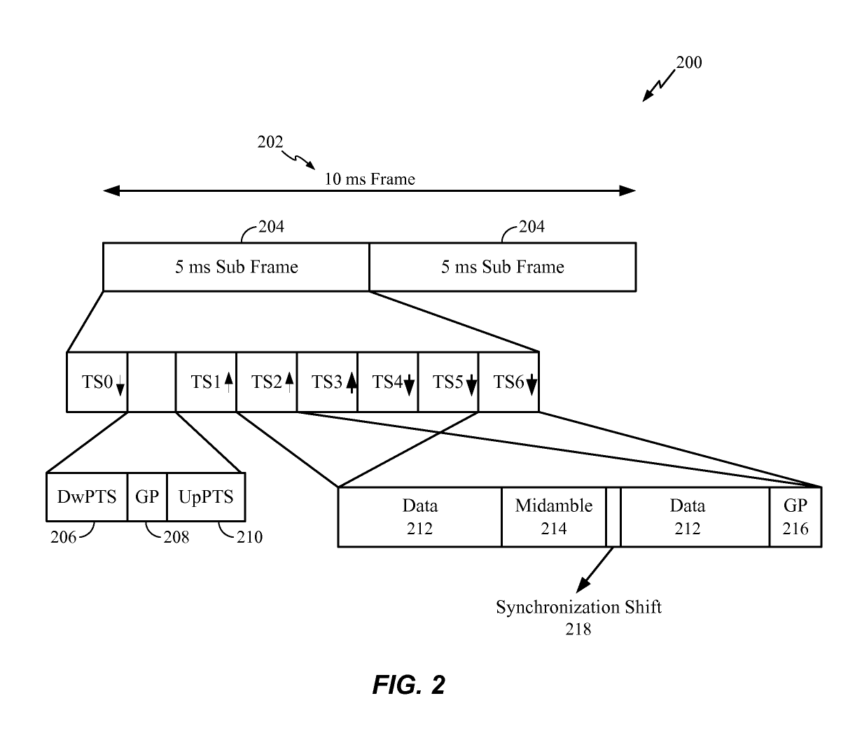

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

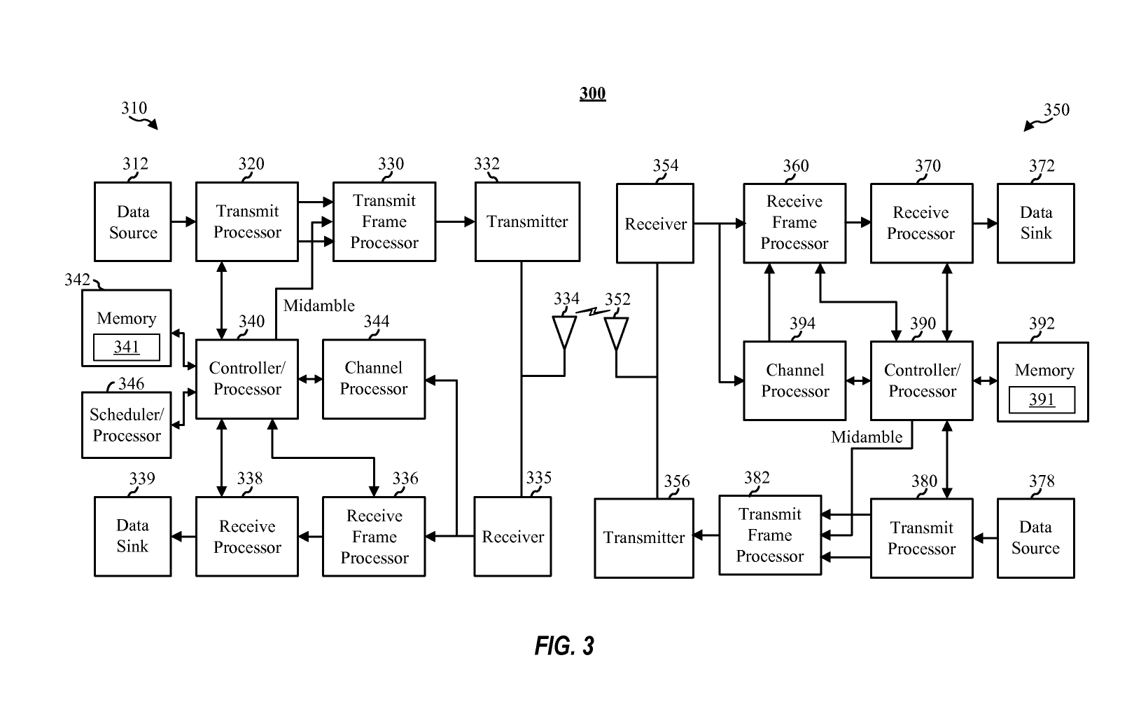

FIG. 3 is a block diagram of a node B 310 in communication with a UE 350 in a RAN 300. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the node B 310 may be used to allocate resources to the UEs and schedule downlink and/or uplink transmissions for the UEs.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a fast return failure handling module 391, which, when executed by the controller/processor 390, configures the UE 350 for handling failure conditions in a high-speed scenario. In another example, the memory 342 of the node B 310 may store a communication module 341 which, when executed by the controller/processor 340, configures the node B 310 for sending one or more connection release messages to the UE 350 for a circuit switched fall back (CSFB) service.

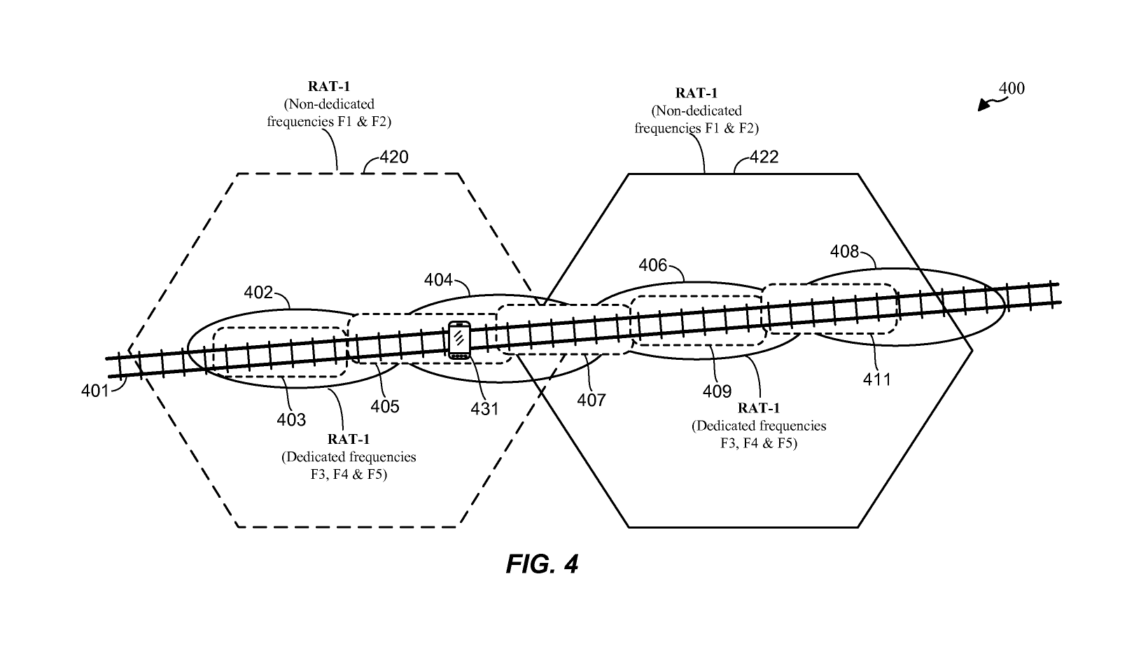

FIG. 4 illustrates a network coverage area example 400 including dedicated networks and a public network, according to aspects of the present disclosure. In one example, the coverage area example 400 for a high-speed train route 401 includes both first RAT (RAT-1) networks and second RAT (RAT-2) networks. In one example, the RAT-1 network is a LTE network, including public and dedicated LTE cells. In the example 400, public LTE cells include public LTE cells 420 and 422 and dedicated LTE cells include 402, 404, 406, and 408. Different LTE frequencies are used for public LTE cells and dedicated LTE cells. For example, LTE frequencies F1 and F2 may be used for the public LTE cells 420 and 422, as shown in the example 400, and LTE frequencies F3, F4 and F5 for dedicated LTE cells 402-408. Similarly, RAT-2 networks may include dedicated RAT-2 cells and public RAT-2 cells. In the example 400, the cells 403, 405, 407, 409 and 411 are dedicated RAT-2 cells such as dedicated TD-SCDMA or GSM cells, etc., which may support circuit-switched services such as voice call services. Also shown in the coverage area example 400 is a user equipment 431, which is in the serving cell 404, a dedicated RAT-1 cell.

In order to ensure high QoS (quality of service) services for UEs in a high-speed scenario, such as traveling on a high-speed train, some service providers have invested in a dedicated high-speed (e.g., LTE) network for UEs on the high-speed trains. The dedicated LTE network may use one or more dedicated LTE frequencies such as frequencies F3-F5, as opposed to non-dedicated frequencies for a public LTE network. The dedicated network is intended for the UEs on the high-speed train. As illustrated in FIG. 4, the dedicated RAT-1 cells 402, 404, 406 and 408 in general have smaller ranges, intended for coverage of limited areas, such as the high-speed train route 401. In contrast, public RAT-1 cells 420 and 422 in general have much larger coverage areas, intended for access by the general public. The public LTE cells 420 and 422 use standardized, non-dedicated frequencies such as F1 and F2.

The UE 431 may move from one cell, such as the dedicated RAT-1 cell 404, to another cell, such as the dedicated RAT-2 cell 405. Alternatively, the UE 431 may move from the dedicated RAT-2 cell 405 to the non-dedicated, public RAT-1 cell 420. The movement of the UE 431 may involve a handover or a cell reselection procedure.

The handover or cell reselection may be performed when the UE 431 moves from a coverage area of a first RAT to the coverage area of a second RAT, or vice versa. A handover or cell reselection may also be performed when there is a coverage hole or lack of coverage in one network, when there is traffic balancing between first RAT and the second RAT networks, or when one network does not support desired services (e.g., circuit switched calls in a circuit switched fall back scenario).

As part of that handover or cell reselection process, while in a connected mode with a first network (e.g., TD-LTE) the UE 431 may be specified to perform a measurement of a neighboring cell. For example, the UE 431 may measure the neighbor cell such as the RAT-2 cell 405 for signal strength, frequency channel, and base station identity code (BSIC). Such measurement may be referred to as inter radio access technology (IRAT) measurement.

The UE 431 may send the serving cell, such as the RAT-1 cell 404, a measurement report indicating results of the IRAT measurement performed by the UE 431. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving cell threshold can be indicated to the UE through dedicated radio resource control (RRC) signaling from the network. The measurement may also include a neighbor cell received signal strength indicator (RSSI). The neighbor cell signal strength can be compared with a neighbor cell threshold. Before handover or cell reselection, in addition to the measurement processes, the base station IDs (e.g., BSICs) may be confirmed and re-confirmed.

### Fast Return Failure Handling in a High-Speed Scenario

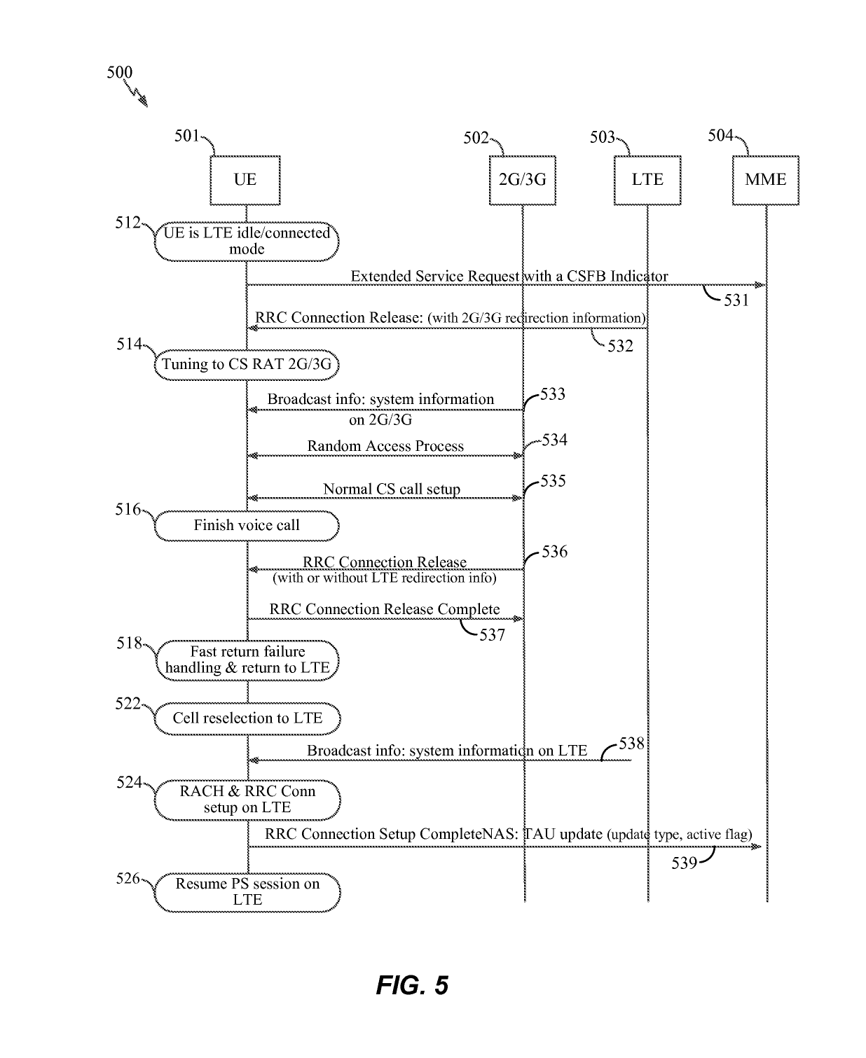

FIG. 5 shows a flow diagram 500 conceptually illustrating an example process for fast return failure handling in a high-speed scenario according to one aspect of the present disclosure. The UE 501 at time 512 may be camped on a dedicated LTE network in a high-speed scenario, such as when the UE 501 is traveling on a high-speed train. Then, the UE 501 may originate or receive a voice call and a redirection service may be invoked to service the voice call.

The redirection service is to redirect the UE from one RAT to another RAT for a particular service and it is commonly used for services such as load balancing, circuit-switched fallback (CSFB) from LTE to other RATs, and others. Example of RATs that the UE is redirected to may include universal mobile telecommunications system (UMTS) frequency division duplex (FDD), UMTS TDD (time division duplex), and global System for mobile communications (GSM).

In this example, the UE 501 is a multimode, CSFB-capable UE supporting 2G/3G and LTE capabilities and may use the CSFB feature for circuit switched (CS) voice services while being camped on a dedicated LTE network 503. The dedicated LTE network 503 may be a dedicated LTE network with at least one dedicated LTE frequency for a high-speed scenario, such as when traveling on a high-speed train, for example at 300 km/h. The UE 501, which is CSFB-capable, may initiate a mobile-originated (MO) circuit switched (CS) voice call while on LTE, resulting in the UE 501 moving to a CS capable 2G/3G network 502. In another example, the UE 501, which may be CSFB-capable, may be paged for a mobile-terminated (MT) voice call while camped on the LTE network 503, also resulting in the UE 501 moving to the 2G/3G network 502 for CS voice call setup.

In either case, at time 531, the UE 501 sends an extended service request (ESR) to a mobility management entity (MME) 504 to initiate a redirection for a CSFB service. A CSFB indicator is included in the ESR message. At time 532, the LTE network 503 sends a radio resource connection (RRC) connection release message with 2G/3G redirection information to initiate a redirection to the CSFB-capable 2G/3G network 502. At time 514, as part of redirection to the 2G/3G network 502, the UE 501 tunes to a 2G/3G RAT to acquire information about the 2G/3G network 502. At time 533, the 2G/3G network 502 broadcasts its system information on a 2G/3G RAT broadcast channel.

At time 534, after receiving the system information, the UE 501 and the 2G/3G network 502 may enter a random access process to establish a connection between the UE 501 and the 2G/3G network 502. At time 535, the UE 501 and the 2G/3G network 502 go through a normal call setup procedure to enable voice call service. At time 516, the UE 501 finishes the voice call.

At time 536, the 2G/3G network 502 sends an RRC connection release message as part of the process to tear down the established connection. The release message may include LTE redirection information to help the UE 501 return to the LTE network 503. At time 537, the UE 501 sends an RRC connection release complete message to complete the connection tear down process. The release message may include a dedicated frequency, as well as public frequencies.

At time 518, upon completion of the CS voice call, a fast return by the UE 501 to the dedicated LTE network 503 is desired for high-speed data service in a high-speed scenario such as when traveling on a high-speed train. An error condition may occur when the quality of the dedicated LTE frequency signal is poor, causing the UE 501 to switch to a nearby public LTE network, such as the RAT-1 cell 420 of FIG. 4, instead of to the dedicated RAT-1 cell 408. Because there are no neighbor cells configured between the dedicated LTE frequency and the public LTE frequency, once the UE on a high-speed train leaves the dedicated LTE frequency, it is difficult for the UE to return to the dedicated LTE Frequency.

It was observed that where a circuit switched call is released from a circuit switched RAT such as the 2G/3G network 502, according to the existing network-based fast return approach, the UE first searches the LTE frequency indicated in a 2G/3G RAT RRC (radio resource control) connection release message. If the measured signal quality of the LTE frequency is below a predefined threshold, the UE attempts to search other LTE frequencies included in an acquisition history, which may result in the UE on the high-speed train leaving the dedicated LTE network. As a result, the UE 501 on a high-speed train may not make a good use of the dedicated LTE network. Additionally, this may impact the public LTE network due to frequent tracking area update (TAU) procedures by the high-speed UE. Not only poor utilization of the dedicated LTE network resources, but also an undue delay for the UE to return to the dedicated LTE network may occur.

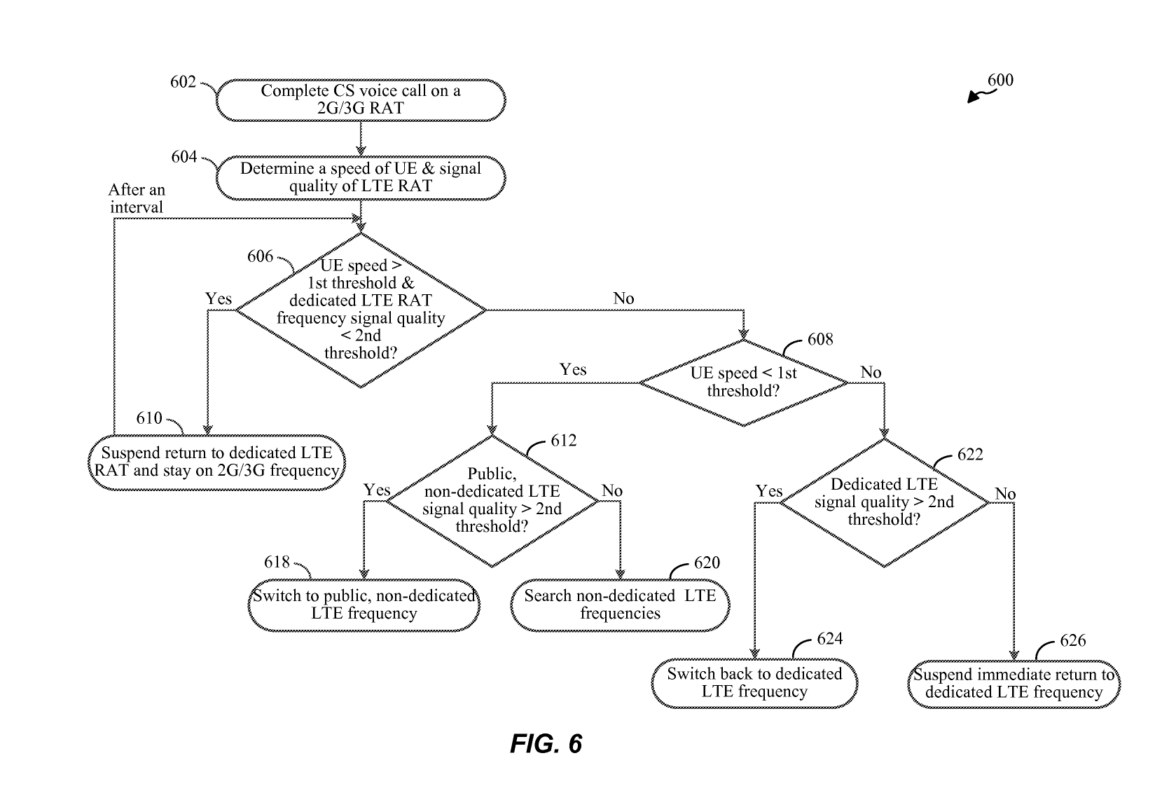

Instead of performing a blind fast return to the LTE frequency after receiving the RRC Connection Release message at time 536, the UE 501, at time 518, performs fast return failure handling if an error condition occurs and may suspend an immediate return to the dedicated LTE network 503. The UE 501 may go through a fast return failure handling process to avoid or minimize any delay of return to the dedicated LTE network 503. A more detailed illustration and description of the fast return failure handling process can be found in FIG. 6 and corresponding sections of the present specification.

At time 522, the UE 501 initiates a cell reselection procedure to return to the LTE network 503 after handling any fast return failures. At time 538, the UE 501 receives broadcast system information from the LTE network 503, as part of the reselection process. At time 524 the UE 501 initiates a physical random access channel (PRACH) procedure to start a connection setup with the dedicated LTE network 503, and at time 539, receives an RRC setup complete message from the dedicated LTE network 503. Once the connection setup is completed, at time 526, the UE 501 may resume its packet service session on the dedicated LTE network 503 that was interrupted by the redirection of the UE 501 to the 2G/3G network 502 for the CS voice call.

FIG. 6 shows a flow diagram 600 illustrating, as an example, a decision process for fast return failure handling at a UE in a high-speed scenario according to one aspect of the present disclosure. The flow diagram 600 is for illustration purposes only and other alternative aspects of the decision process for the fast return failure handling for a high-speed scenario are possible.

At block 602, the UE completes a circuit switched voice call on a 2G/3G network. The UE and the 2G/3G network of FIG. 6 may be the UE 501 and the 2G/3G network 502 of FIG. 5. Instead of blindly returning to a dedicated LTE network such as the dedicated LTE network 503 in FIG. 5, the UE, at block 604, first determines a speed of the UE and a signal quality of an LTE frequency included in a connection release message. The UE speed may be determined via at least one of a variety of techniques, such as a measurement of a filtered Doppler frequency and a measurement input from a GPS unit. The signal quality may be measured based on reference signal code power (RSCP), reference signal received power (RSRP), reference signal received quality (RSRQ), signal to noise ratio (SNR), and/or some other measurement metrics.

At decision block 606, if the UE speed is above a predetermined threshold, meaning that the UE is in a high-speed scenario such as on a high-speed train, and the signal quality of the dedicated LTE frequency is below a predetermined threshold, the UE, at block 610, may suspend an immediate return to the dedicated LTE frequency and stay at the 2G/3G RAT frequency instead. After a predetermined interval, the UE may return to decision block 606 and check to see if the conditions have changed in such a way that the UE may return to the dedicated LTE frequency. This may avoid some of the potential issues associated with a blind return to the LTE frequency upon completing a circuit-switched voice call, as discussed earlier.

On the other hand, if the UE speed is below a predetermined threshold, or the signal quality of the dedicated LTE frequency is above a predetermined threshold, or both, the UE, at decision block 608 first determines whether the UE speed is below the predetermined threshold. If yes, it means that the UE is in a non-high-speed scenario and is in a public, non-dedicated wireless network such as a public LTE network.

At decision block 612, the UE further determines whether the signal quality of the public, non-dedicated LTE frequency included in the connection release message is above a predetermined threshold. If yes, at block 618, the UE switches to the public, non-dedicated LTE network. This may occur in various scenarios. For example, the UE may just come off a high-speed train or the UE is not in a high-speed scenario to begin with.

If the signal quality of the public, non-dedicated LTE network is not above the predetermined threshold, the UE, at block 620, may search additional public, non-dedicated LTE frequencies to switch to, as part of a reselection procedure. The additional non-dedicated LTE frequencies may be found in the UE's acquisition history or in a release message received from the serving cell.

The other path from decision block 608 is followed when the UE speed is above the predetermined threshold, meaning that the UE is in a high-speed scenario. Then, at decision block 622, the UE further determines whether the signal quality of the dedicated LTE frequency is above the predetermined threshold. If yes, at block 624, the UE returns to the LTE frequency of the dedicated LTE network and may continue the interrupted packet service session initiated before the redirection for the circuit switched voice call.

If the signal quality of the dedicated LTE frequency is below the predetermined threshold, the UE, at block 626, is in the same situation as the UE at block 610 and may suspend an immediate return to the dedicated LTE frequency and stay at the 2G/3G frequency. In one configuration, there may be multiple dedicated LTE frequencies included in the connection release message and/or in the UE's record including an acquisition history and the UE may search the additional dedicated LTE frequencies, as part of a reselection procedure.

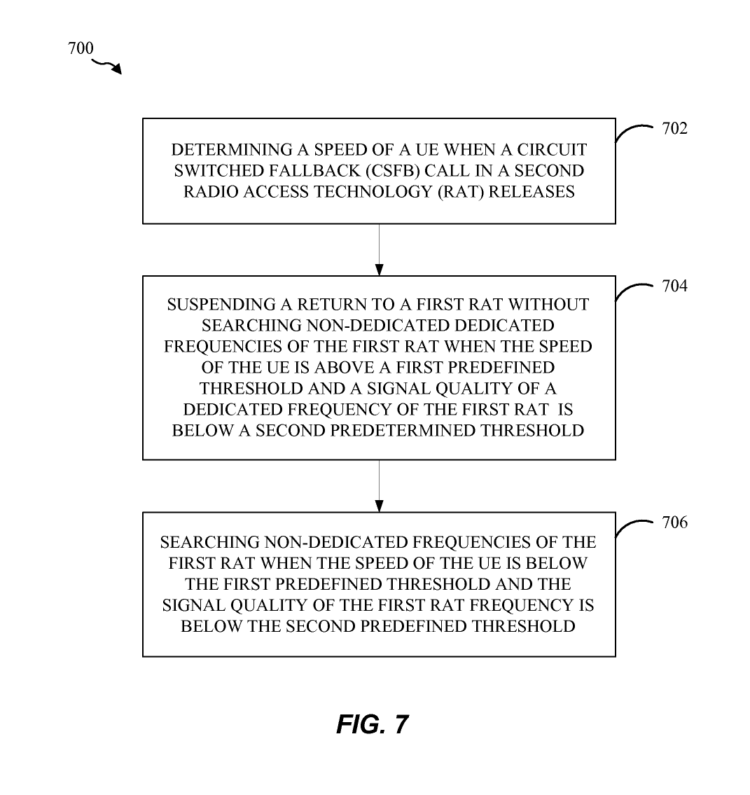

FIG. 7 is a flow diagram illustrating a method 700 for fast return failure handling at a UE in a high-speed scenario according to one aspect of the present disclosure. At block 702, the UE determines a UE speed and a signal quality of a first RAT frequency, such as a dedicated LTE frequency, when a CSFB call releases. The UE speed may be determined by one or more of a variety of techniques, as described earlier. The signal quality may be measured based on one or more measurement metrics, as describe earlier.

At block 704, if the UE speed is above a predetermined threshold, meaning that the UE is in a high-speed scenario, such as on a high-speed train, and the signal quality of a dedicated LTE frequency is below a predetermined threshold, the UE suspends normal return to a dedicated first RAT frequency, such as an LTE frequency, without searching any non-dedicated first RAT frequencies of neighbor cells. The non-dedicated frequencies of the first RAT may be from a record at the UE such as an acquisition history of the UE or from a release message. The suspending of return to the LTE frequency may also include staying at the 2G/3G RAT frequency and checking again to see if the conditions have changed in such a way the UE may return to the dedicated LTE frequency. This may avoid some of the potential issues associated with a blind return to the LTE upon completing a CS voice call, as discussed earlier.

According to one aspect of the present disclosure, the UE may return to the first RAT when the signal quality of an additional dedicated frequency of the first RAT is above the second predetermined threshold. The additional dedicated frequency may be included in the record of the UE. Additionally, the UE may return to the first RAT when the signal quality of the additional dedicated frequency of the first RAT is above the second predetermined threshold and the additional dedicated frequency is included in the release message.

At block 706, the UE searches non-dedicated frequencies of the first RAT if the signal quality of the first RAT frequency included in the connection release message is below the predetermined threshold and the UE speed is below the predetermined threshold. This means that the UE is in a non-high-speed scenario such as on a public LTE network. The UE may search public, non-dedicated frequencies of the first RAT, as part of a reselection procedure. According to one aspect of the present disclosure, the method 700 may include returning to a first RAT frequency when the signal quality of the dedicated frequency becomes higher than the second predefined threshold. In another scenario, the UE may return to a dedicated frequency when the non-dedicated is not above another threshold value (e.g., a third threshold). This occurs when the UE is in a non-high-speed scenario and the dedicated frequency is above a threshold (e.g., second threshold).

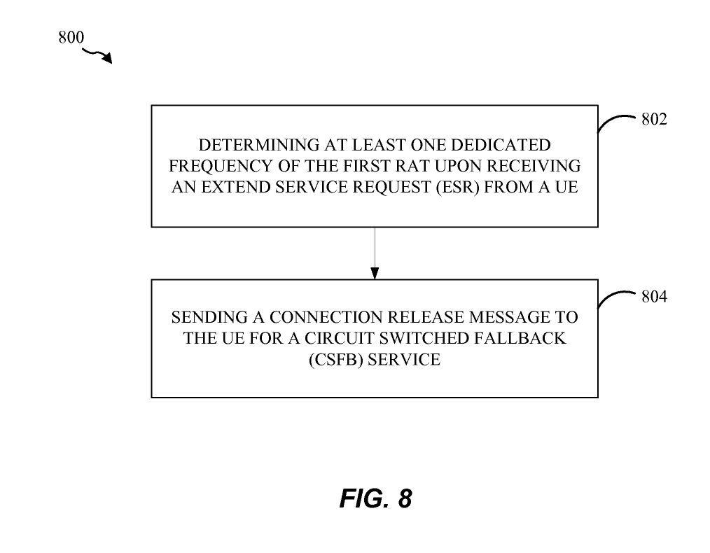

FIG. 8 is a flow diagram illustrating a method 800 for fast return failure handling at a wireless network node in a high-speed scenario according to another aspect of the present disclosure. At block 802, a network node such as the NodeB 310 of FIG. 3 may determine and select at least one dedicated first RAT frequency upon receiving an extend service request (ESR) from a UE, based on measurement reports from the UE. In some cases, if multiple dedicated frequencies are available, more than one dedicated frequencies can be included in a connection release message. As described earlier, the ESR message may indicate that the UE is attempting to initiate a redirection for a CSFB call at a second RAT such as the 2G/3G network 502 of FIG. 5.

At block 804, the NodeB may send a connection release message to the UE in order to accommodate the circuit switched fallback (CSFB) call that the UE initiated with the ESR message. In one aspect, the NodeB may include the selected, dedicated first RAT frequency for the UE to switch to after the CSFB call. In one configuration, the connection release message does not include any non-dedicated frequencies. It is also possible for the connection release message to include at least one dedicated frequency of a second RAT.

Alternatively or in addition, the NodeB may send a second connection release message based on the UE speed and the signal quality of the first RAT frequency. For example, if the NodeB determines that the UE is in a non-high-speed scenario based on the UE speed, the NodeB may further determine at least one non-dedicated first RAT frequency for the UE to switch to after the CSFB call, based on the signal quality of the non-dedicated first RAT frequency. Then the NodeB may include the non-dedicated first RAT frequency in the second connection release message and send the message to the UE. For example, the NodeB may determine the UE speed based on an uplink signal Doppler frequency measurement.

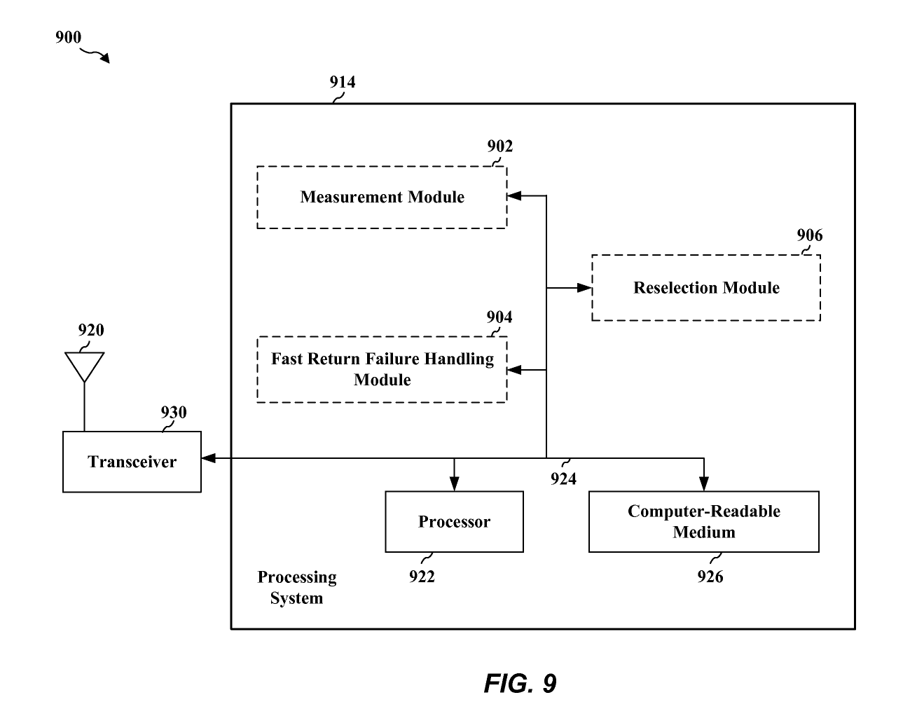

FIG. 9 is a block diagram illustrating an example of a hardware implementation for an apparatus 900 employing a processing system 914 with different modules/means/components for fast return failure handling in a high-speed scenario in an example apparatus according to one aspect of the present disclosure. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 922 the modules 902, 904, 906 and the non-transitory computer-readable medium 926. The bus 924 may also link various other circuits such as timing sources, peripherals, voltage regulators, and power management circuits, which are well known in the art, and therefore, will not be described any further.

The apparatus includes a processing system 914 coupled to a transceiver 930. The transceiver 930 is coupled to one or more antennas 920. The transceiver 930 enables communicating with various other apparatus over a transmission medium. The processing system 914 includes a processor 922 coupled to a non-transitory computer-readable medium 926. The processor 922 is responsible for general processing, including the execution of software stored on the computer-readable medium 926. The software, when executed by the processor 922, causes the processing system 914 to perform the various functions described for any particular apparatus. The computer-readable medium 926 may also be used for storing data that is manipulated by the processor 922 when executing software.

The processing system 914 includes a measurement module 902 for determining a speed of the UE and signal qualities of dedicated or non-dedicated frequencies of different RATs. The processing system 914 also includes a fast return failure handling module 904 for suspending a UE from returning to a dedicated first RAT frequency such as a LTE frequency if the UE speed is above a predetermined threshold and the signal quality of a first RAT frequency is below another predetermined threshold. The processing system 914 may also include a reselection module for searching dedicated or non-dedicated frequencies of a first RAT such as an LTE network as part of the reselection procedure. The modules 902, 904 and 906 may be software modules running in the processor 922, resident/stored in the computer-readable medium 926, one or more hardware modules coupled to the processor 922, or some combination thereof The processing system 914 may be a component of the UE 350 of FIG. 3 and may include the memory 392, and/or the controller/processor.

In one configuration, an apparatus such as a UE 350 is configured for wireless communication including means for determining a speed of the UE and signal qualities of dedicated or non-dedicated frequencies of the different RATs. In one aspect, the determining means may be the antennas 352, the receiver 354, the channel processor 394, the receive frame processor 360, the receive processor 370, the transmitter 356, the transmit frame processor 382, the transmit processor 380, the controller/processor 390, the memory 392, measurement module 902, and/or the processing system 914 configured to perform the functions recited by the determining means.

The UE 350 is also configured to include means for suspending an immediate return to a dedicated first RAT. In one aspect, the suspending means may include the antennas 352, the receiver 354, the channel processor 394, the receive frame processor 360, the receive processor 370, the transmitter 356, the transmit frame processor 382, the transmit processor 380, the controller/processor 390, the memory 392, the fast return failure handling module 904, and/or the processing system 914 configured to perform the functions recited by the suspending means. In one configuration, the means and functions correspond to the aforementioned structures. In another aspect, the aforementioned means may be a module or any apparatus configured to perform the functions recited by the suspending means.

The UE 350 is also configured to include means for searching non-dedicated frequencies of the first RAT. In one aspect, the searching means may include the antennas 352, the receiver 354, the channel processor 394, the receive frame processor 360, the receive processor 370, the controller/processor 390, the memory 392, the reselection module 906, and/or the processing system 914 configured to perform the functions recited by the searching means. In one configuration, the means and functions correspond to the aforementioned structures. In another aspect, the aforementioned means may be a module or any apparatus configured to perform the functions recited by the searching means.

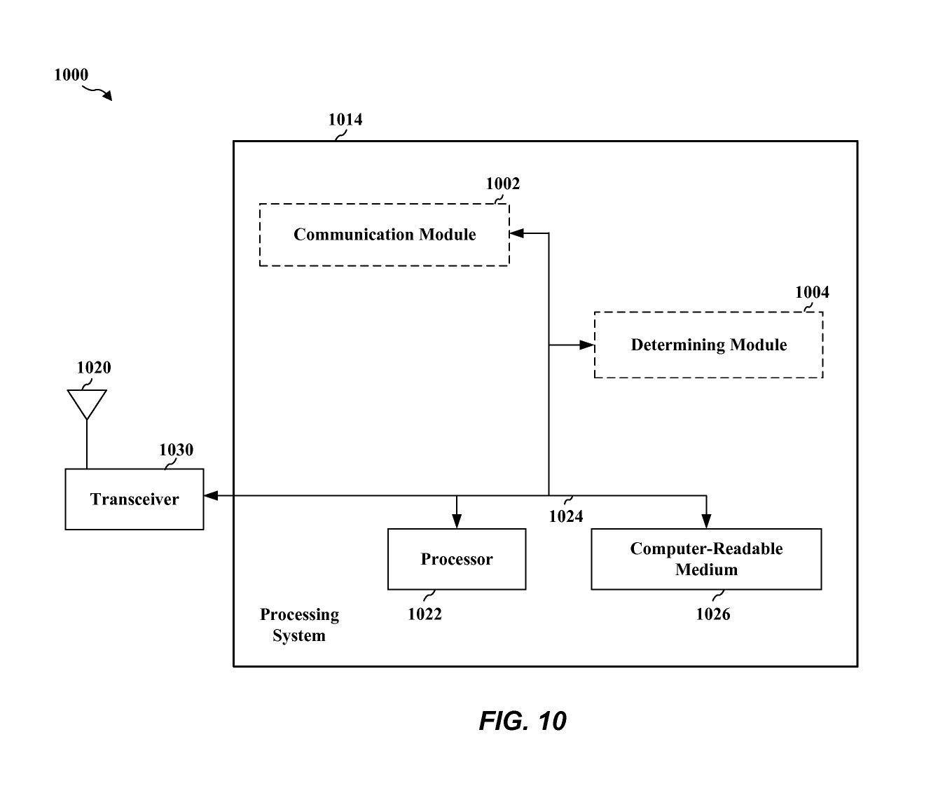

FIG. 10 is a block diagram illustrating an example of a hardware implementation for an apparatus 1000 employing a processing system 1014 with different modules/means/components for fast return failure handling in a high-speed scenario in an example apparatus according to one aspect of the present disclosure. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022 the modules 1002, 1004 and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a communication module 1002 for sending a connection release message and a determining module 1004. The modules 1002, 1004 may be software modules running in the processor 1022, resident/stored in the computer-readable medium 1026, one or more hardware modules coupled to the processor 1022, or some combination thereof The processing system 1014 may be a component of the NodeB 310 of FIG. 3 and may include the memory 392 and/or the controller/processor 340.

The NodeB 310 is configured to include means for sending a connection release message. In one aspect, the sending means may include the antennas 334, the transmit processor 320, transmit frame processor 330, the transmitter 332, the controller/processor 340, the memory 342, the communication module 1002, the communication module 341, and/or the processing system 1014 configured to perform the functions recited by the sending means. In one configuration, the means and functions correspond to the aforementioned structures. In another aspect, the aforementioned means may be any module or any apparatus configured to perform the functions recited by the sending means.

The NodeB 310 is also configured to include means for determining a dedicated frequency. In one aspect, the determining means may include the controller/processor 340, the memory 392, the determining module 1004, the communication module 341, and/or the processing system 1014 configured to perform the functions recited by the determining means. In one configuration, the means and functions correspond to the aforementioned structures. In another aspect, the aforementioned means may be a module or any apparatus configured to perform the functions recited by the sending means.

Several aspects of a telecommunications system has been presented with reference to LTE (in FDD, TDD, or both modes), 2G/3G RATs such as GSM, TD-SCDMA and CDMA2000, and evolution-data optimized (EV-DO). As those skilled in the art will readily appreciate, various aspects described throughout this disclosure may be extended to other telecommunication systems, network architectures and communication standards. By way of example, various aspects may be extended to other systems such as or LTE-advanced (LTE-A), W-CDMA, high speed downlink packet access (HSDPA), high speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication at a user equipment (UE), comprising:
determining a speed of the UE when a circuit switched fallback (CSFB) call in a second radio access technology (RAT) releases;
suspending a return to a first RAT without searching non-dedicated frequencies of the first RAT when the speed of the UE is above a first predefined threshold and a signal quality of a dedicated frequency of the first RAT, included in a release message from the second RAT or in a record of the UE, is below a second predetermined threshold; and
searching the non-dedicated frequencies of the first RAT when the speed of the UE is below the first predefined threshold and the signal quality of the dedicated frequency of the first RAT, included in the release message or in the record of the UE, is below the second predetermined threshold.

2. The method of claim 1, further comprising returning to the first RAT when a signal quality of an additional dedicated frequency of the first RAT is above the second predetermined threshold and the additional dedicated frequency is from the record of the UE.

3. The method of claim 1, further comprising returning to the first RAT when the signal quality of the dedicated frequency of the first RAT is above the second predetermined threshold and is from the release message.

4. The method of claim 1, in which searching the non-dedicated frequencies comprises searching non-dedicated frequencies of the first RAT from an acquisition history in the record of the UE.

5. The method of claim 1, further comprising returning to the first RAT when the speed of the UE is below the first predefined threshold and the signal quality of the dedicated frequency of the first RAT included in the release message is above the second predetermined threshold and signal qualities of the non-dedicated frequencies of the first RAT are below a third threshold.

6. The method of claim 1, in which suspending the return to the first RAT comprises staying on a selected frequency of the second RAT, from which the CSFB call was released.

7. An apparatus for wireless communication, comprising:
a memory; and
at least one processor coupled to the memory and configured:
to determine a speed of a user equipment (UE) when a circuit switched fallback (CSFB) call in a second radio access technology (RAT) releases;
to suspend a return to a first RAT without searching non-dedicated frequencies of the first RAT when the speed of the UE is above a first predefined threshold and a signal quality of a dedicated frequency of the first RAT, included in a release message from the second RAT or in a record of the UE, is below a second predetermined threshold; and
to search the non-dedicated frequencies of the first RAT when the speed of the UE is below the first predefined threshold and the signal quality of the dedicated frequency of the first RAT, included in the release message or in the record of the UE, is below the second predetermined threshold.

8. The apparatus of claim 7, in which the at least one processor is further configured to return the UE to the first RAT when a signal quality of an additional dedicated frequency of the first RAT is above the second predetermined threshold and the additional dedicated frequency is from the record of the UE.

9. The apparatus of claim 7, in which the at least one processor is further configured to return to the first RAT when the signal quality of the dedicated frequency of the first RAT is above the second predetermined threshold and is from the release message.

10. The apparatus of claim 7, in which the at least one processor is further configured to search non-dedicated frequencies of the first RAT from an acquisition history in the record of the UE.

11. The apparatus of claim 7, in which the at least one processor is further configured to return to the first RAT when the speed of the UE is below the first predefined threshold and the signal quality of the dedicated frequency of the first RAT included in the release message is above the second predetermined threshold and signal qualities of the non-dedicated frequencies of the first RAT are below a third threshold.

12. The apparatus of claim 7, in which the at least one processor is further configured to suspend the return to the first RAT by staying on a selected frequency of the second RAT, from which the CSFB call was released.

13. A method of wireless communication at a node of a dedicated network of a first radio access technology (RAT), comprising:
sending a first connection release message to a user equipment (UE) for a circuit switched fallback (CSFB) service including at least one dedicated frequency of the first RAT.

14. The method of claim 13, further comprising sending to the UE a second connection release message including at least one non-dedicated frequency of the first RAT.

15. The method of claim 13, in which the first connection release message includes at least one dedicated frequency of a second RAT.

16. The method of claim 13, in which the first connection release message does not include any non-dedicated frequencies.

17. An apparatus for wireless communication, comprising:
a memory; and
at least one processor coupled to the memory and configured:
to send a first connection release message from a node of a dedicated network of a first radio access technology (RAT) to a user equipment (UE) for a circuit switched fallback (CSFB) service including at least one dedicated frequency of the first RAT.

18. The apparatus of claim 17, in which the at least one processor is further configured to send to the UE a second connection release message including at least one non-dedicated frequency of the first RAT.

19. The apparatus of claim 17, in which the first connection release message includes at least one dedicated frequency of a second RAT.

20. The apparatus of claim 17, in which the first connection release message does not include any non-dedicated frequencies.
